(19) United States
(12) Patent Application Publication
(10) Pub. No.: US 2026/0268504 A1
(43) Pub. Date: Sep. 10, 2026

(54) VIDEO PROCESSING APPARATUS, VIDEO PROCESSING METHOD, PROGRAM, AND VIDEO PROCESSING SYSTEM

(71) Applicant: Sony Group Corporation, Tokyo (JP)

(72) Inventors: Maho Ito, Tokyo (JP); Yuya Takayama, Tokyo (JP); Seishi Tomonaga, Kanagawa (JP); Kosuke Yoshitomi, Kanagawa (JP); Tetsuhiro Uchida, Tokyo (JP); Takashi Takamatsu, Tokyo (JP)

(73) Assignee: Sony Group Corporation, Tokyo (JP)

(21) Appl. No.: 19/166,688

(22) PCT Filed: Mar. 8, 2024
(86) PCT No.: PCT/JP2024/008953

§ 371 Date: Sep. 18, 2025

(30) Foreign Application Priority Data
Mar. 31, 2023 (JP) 2023-058593

(51) Int. Cl. G06T 7/246; G06F 3/01; G06T 7/73; G06T 11/00; G06T 13/00

(52) U.S. Cl. CPC G06T 7/246; G06F 3/013; G06T 7/73; G06T 11/00; G06T 13/00; G06T 2207/10016; G06T 2207/30196; G06T 2207/30268

(57) ABSTRACT

[Object] The present disclosure relates to a video processing apparatus, a video processing method, program, and a video processing system that provide a more comfortable viewing experience.

[Solving Means] A video moving direction calculation section that calculates a direction in which a video moves based on a content of a video content displayed by a video presentation section in a vehicle. A scenery moving direction calculation section that calculates a direction in which a scenery outside the vehicle moves based on the vehicle's motion. A presented video creation section that creates a video displayed by the video presentation section by applying an effect to the video content based on both the video moving direction and the scenery moving direction. This technology can be applied, for example, to a video content distribution system that distributes video content to a vehicle.

### TECHNICAL FIELD

This disclosure relates to a video processing apparatus, a video processing method, a program, and a video processing system, and more particularly to a video processing apparatus, a video processing method, a program, and a video processing system that provide a more comfortable viewing experience.

### BACKGROUND ART

In recent years, with the spread of automated driving in vehicles, it is expected that passengers in vehicles will have increased opportunities to view video content while in motion. However, when passengers view video content in a moving vehicle, they may experience motion sickness, such as motion sickness or video sickness (hereinafter referred to as “motion sickness”). Therefore, there is concern that the comfortable viewing experience of video content may be impaired, and there is a need to reduce this risk.

For example, Patent Literature 1 discloses a vehicle control system that controls the display of images that can be displayed during autonomous driving in response to the vehicle's motion to suppress motion sickness in vehicle occupants during autonomous driving.

### CITATION LIST

### Patent Literature

Patent Literature 1: Japanese Patent Application Laid-open No. 2018-076027

### DISCLOSURE OF INVENTION

### Technical Problem

However, in the method disclosed in Patent Literature 1, image display control is performed solely in response to vehicle motion, and the content of the images is not taken into consideration. As a result, even in cases where image display control to suppress motion sickness in occupants is not necessary, such control may still be performed, potentially compromising the comfort of the viewing experience.

This disclosure is made in light of such circumstances and is intended to provide a more comfortable viewing experience.

### Solution to Problem

According to an aspect of the present disclosure, there is provided a video processing apparatus, including:
a video moving direction calculation section that calculates a direction in which a video moves based on a content of a video content displayed by a video presentation section in a vehicle;
a scenery moving direction calculation section that calculates a direction in which a scenery outside the vehicle moves based on the vehicle's motion; and
a presented video creation section that creates a video displayed by the video presentation section by applying an effect to the video content based on both the video moving direction and the scenery moving direction.

According to an aspect of the present disclosure, there is provided a video processing method or a program, including:
calculating a direction in which a video moves based on a content of a video content displayed by a video presentation section in a vehicle;
calculating a direction in which a scenery outside the vehicle moves based on the vehicle's motion; and
creating a video displayed by the video presentation section by applying an effect to the video content based on both the video moving direction and the scenery moving direction.

According to an aspect of the present disclosure, there is provided a video processing system, including:
a video moving direction calculation section that calculates a direction in which a video moves based on a content of a video content displayed by a video presentation section in a vehicle;
a scenery moving direction calculation section that calculates a direction in which a scenery outside the vehicle moves based on the vehicle's motion;
a presented video creation section that creates a video displayed by the video presentation section by applying an effect to the video content based on both the video moving direction and the scenery moving direction; and
the video presentation section that displays the video.

In one aspect of the present disclosure, the video moving direction, which is the direction in which the video moves in response to the content of the video content displayed on the video presentation section in the vehicle, is determined, the scenery moving direction, which is the direction in which the scenery outside the vehicle moves in response to the vehicle's motion, is determined, and an effect is applied to the video content based on both the video moving direction and the scenery moving direction, thereby creating the video displayed on the video presentation section.

### BRIEF DESCRIPTION OF DRAWINGS

FIG. 1 A block diagram showing an example of the configuration of an embodiment of a video content distribution system applying this technology;

FIG. 2 A diagram illustrating the video moving direction and scenery moving direction;

FIG. 3 A diagram showing an example of video content with mosaic-based effect processing applied;

FIG. 4 A diagram showing an example of video content with effect processing using a mask;

FIG. 5 A block diagram showing an example of the first configuration of a video content distribution system;

FIG. 6 A diagram illustrating the scenery moving direction;

FIG. 7 A diagram showing examples of effects and parameters;

FIG. 8 A flowchart illustrating the first effect processing;

FIG. 9 A flowchart illustrating the effect parameter decision process;

FIG. 10 A block diagram showing a second configuration example of the video content distribution system;

FIG. 11 A diagram illustrating the effect processing in which effects are applied to areas other than the central vision region;

FIG. 12 A diagram illustrating the video moving direction in the central vision region and the scenery moving direction in the peripheral vision region outside the content area;

FIG. 13 A diagram illustrating the video moving direction in the central vision region and the scenery moving direction in the peripheral vision region outside the central vision region;

FIG. 14 A diagram illustrating an example of subdividing the peripheral vision region to determine the scenery moving direction;

FIG. 15 A flowchart illustrating the second effect processing;

FIG. 16 A diagram illustrating the correction of the vertical direction of the scenery moving direction;

FIG. 17 A block diagram showing a first modified example of the video content distribution system;

FIG. 18 A block diagram showing a second modified example of the video content distribution system; and

FIG. 19 A block diagram showing an example of the configuration of a computer implementing the present technology.

### MODE(S) FOR CARRYING OUT THE INVENTION

The following describes in detail specific embodiments of the present technology with reference to the drawings.

### <Example of a Video Content Distribution System Configuration>

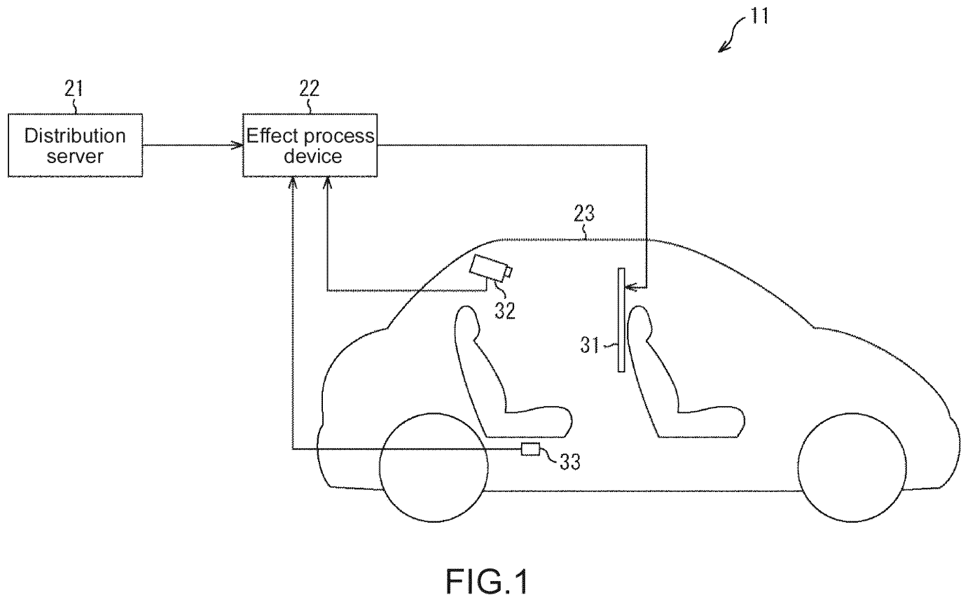

FIG. 1 is a block diagram showing an example of the configuration of an embodiment of a video content distribution system applying this technology.

As shown in FIG. 1, the video content distribution system 11 is configured so that video content distributed from the distribution server 21 is provided to the vehicle 23 via the effect process device 22. For example, the distribution server 21 may be a streaming device, a video content playback device, a Blu-ray (registered trademark) disk playback device, or the like. Vehicle 23 is configured to display video content on a video presentation section 31 and to supply video data captured by a camera 32 or acceleration data detected by an acceleration sensor 33 to the effect process device 22. The camera 32 is installed such that the video presentation section 31 and the surrounding area of the video presentation section 31 (e.g., the windows of vehicle 23) are included in the vision region.

In the video content distribution system 11, the effect process device 22 performs effect processing to apply appropriate effects to the video content to reduce motion sickness based on both the vehicle 23's motion (such as movement or shaking) derived from the video data or acceleration data and the movement of the video content, and provides the video content to the vehicle 23. In this way, the video content distribution system 11 can reduce motion sickness that may occur when users view video content in a moving vehicle 23 by performing effect processing that takes into account not only the motion of the vehicle 23 but also the movement of the video content.

For example, motion sickness is believed to be caused by a difference between self-posture recognition and visual information. Specifically, in a forward-moving vehicle 23, the scenery appears to flow backward relative to the user, allowing the user to recognize that they are moving forward. When video content displayed on the video presentation section 31 moves in the opposite direction of the vehicle's movement, such as flowing toward the user's front, the user perceives the content as moving in a way that contradicts their perception of forward motion, potentially triggering motion sickness.

Furthermore, visual information includes central and peripheral vision. While central vision allows clear perception of objects, peripheral vision enables recognition of moving objects. Users of the moving vehicle 23 perceive their direction of movement through this peripheral vision. Therefore, by applying effect processing corresponding to the magnitude of the difference between the movement of images in central and peripheral vision, it is possible to implement measures to reduce motion sickness in proportion to the severity of motion sickness.

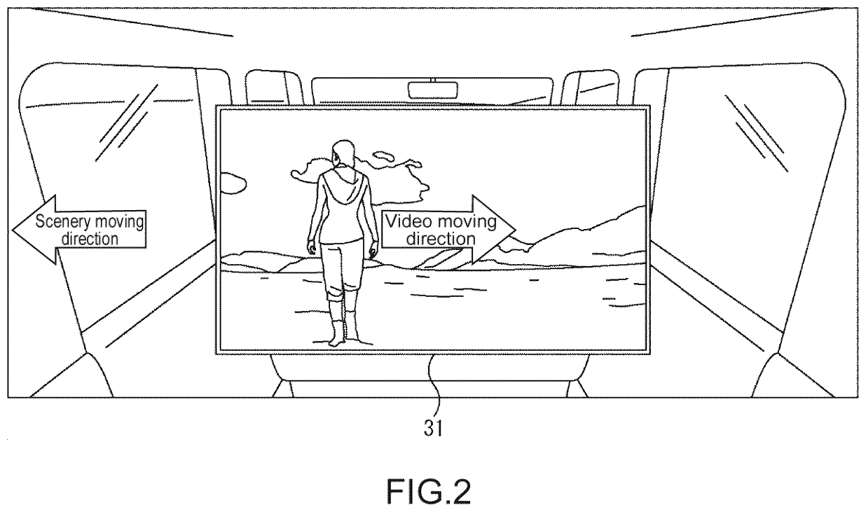

For example, as shown in FIG. 2, in the content area, which is the area where video content is displayed by the video presentation section 31, the direction in which the video moves is defined as the video moving direction based on the content of the video content being viewed by the user. Here, the entire content area may be defined as the central vision region, or a portion of the content area specified based on the user's gaze may be defined as the central vision region. Furthermore, in the area estimated to be the user's vision region, the area outside the central vision region is defined as the peripheral vision region. The direction of movement in the peripheral vision region is defined as the scenery moving direction. For example, the scenery moving direction can be set as the direction of movement of the scenery visible through a window in the peripheral visual field area. Furthermore, the direction of movement of the scenery can be calculated based on the direction of movement of vehicle 23. When the video moving direction and the scenery moving direction are inconsistent, motion sickness may be induced due to this inconsistency.

Therefore, the video content distribution system 11 executes effect processing that applies appropriate effects to the video content in accordance with the difference between the scenery moving direction and the video moving direction, thereby providing a more comfortable viewing experience.

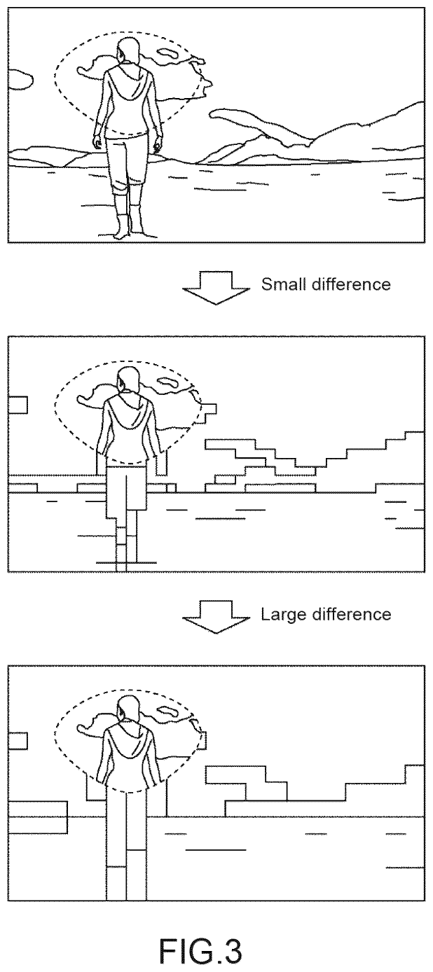

For example, FIG. 3 shows an example of video content to which an effect processing using a mosaic effect has been applied as an effect to reduce motion sickness.

In the example shown in FIG. 3, motion sickness reduction effects are applied to the content area outside the central vision region (the area enclosed by the dashed line) of the content area where the video content is displayed, based on the user's gaze. When the difference between the scenery moving direction and the video moving direction is small, a small size is applied as the parameter specifying the mosaic size, and as shown in the middle of FIG. 3, the video content outside the central vision region is processed with a mosaic effect using a small size. On the other hand, when the difference between the scenery moving direction and the video moving direction is large, a large size is applied as the parameter specifying the mosaic size, and an effect processing is applied to mosaic the video content outside the central visual field area with a large size, as shown in the lower part of FIG. 3.

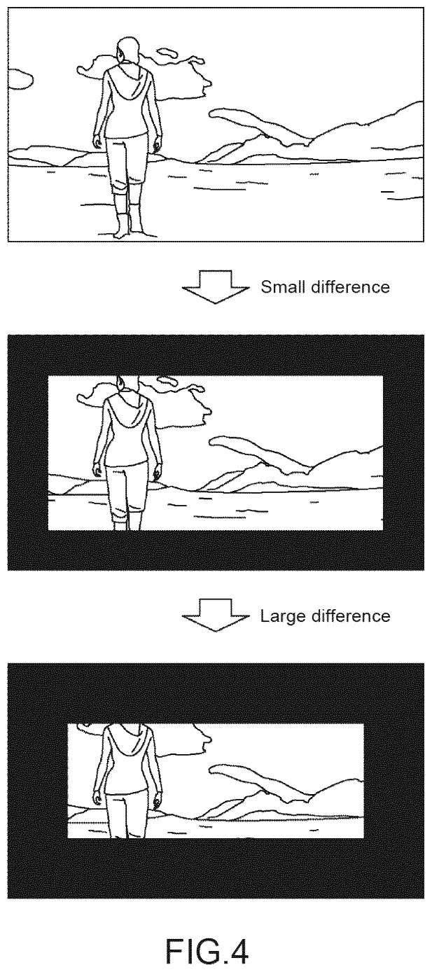

Additionally, FIG. 4 shows an example of video content with an effect processing using a mask as an effect to reduce motion sickness.

In the example shown in FIG. 4, an effect to reduce motion sickness is applied to the entire content area where the video content is displayed as the central vision region. When the difference between the scenery moving direction and the video moving direction is small, a narrow width is applied as the parameter specifying the mask width, and an effect processing is applied to mask the entire edge of the video content with a narrow width, as shown in the middle of FIG. 4. On the other hand, when the difference between the scenery moving direction and the video moving direction is large, the “wide” parameter is applied to specify the mask width, and an effect processing is applied to mask the entire edge of the video content with a wide mask, as shown in the lower part of FIG. 3.

In this way, the video content distribution system 11 can reduce motion sickness by applying effects to the video content using parameters based on the difference between the scenery moving direction and the video moving direction.

### <First Configuration Example of the Video Content Distribution System>

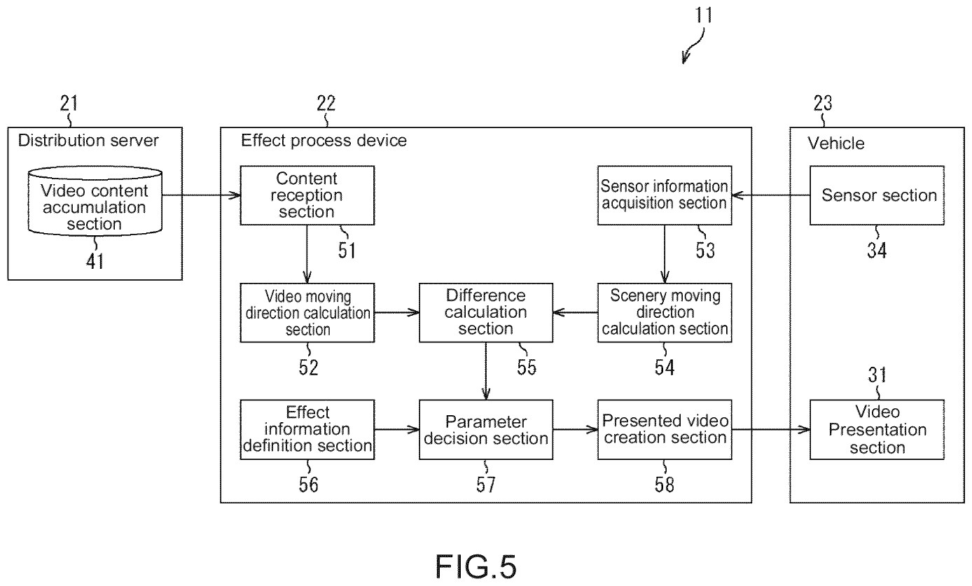

Referring to FIGS. 5 to 9, the first configuration example of the video content distribution system 11 is described.

FIG. 5 shows a block diagram of the video content distribution system 11.

As shown in FIG. 5, the video content distribution system 11 is configured by a distribution server 21, an effect process device 22, and a vehicle 23 connected via a communication network.

The distribution server 21 is configured with a video content accumulation section 41 that stores various video contents to be distributed by the video content distribution system 11. The distribution server 21 reads the desired video content from the video content accumulation section 41 in response to a request from a user riding in the vehicle 23 and transmits it to the effect process device 22.

The effect process device 22 is configured with a content reception section 51, a video moving direction calculation section 52, a sensor information acquisition section 53, a scenery moving direction calculation section 54, a difference calculation section 55, an effect information definition section 56, a parameter decision section 57, and a presented video creation section 58. The effect process device 22 is a video processing device that performs effect processing to apply effects appropriate for reducing motion sickness to video content in accordance with the difference between the scenery moving direction and the video moving direction.

The content receiving unit 51 receives video content transmitted from the distribution server 21 and supplies it to the video moving direction calculation section 52.

The video moving direction calculation section 52 analyzes the video content supplied from the content reception section 51 and calculates the video moving direction based on the optical flow derived from the content of the video content. For example, in the video content distribution system 11, the video moving direction is calculated with the entire content area as the central vision region.

For example, the video moving direction is the direction of change in the video that occurs due to camera movements or the movement of characters during the production of the video content, and it can be calculated using dense optical flow. For example, optical flow is a technique that enables the calculation of video motion as vectors by comparing pixel information between two consecutive frames. This allows the vectors representing the movement of each pixel within a frame to be obtained. Based on these vectors, the average of the optical flow for all pixels can be used as the video moving direction, or the optical flow can be sampled every N pixels and reduced to 1/(N*N) optical flows, with the average of these being used as the video moving direction. Alternatively, the average of vectors of size L or larger can be used as the video moving direction.

The sensor section 34 includes, for example, the camera 32 or the acceleration sensor 33 shown in FIG. 1. Additionally, it may be configured to include a GPS (Global Positioning System) sensor for detecting the position of the vehicle 23, a sensor for detecting the steering angle of the vehicle 23's steering wheel, or a camera of the drive recorder installed on the vehicle 23.

The sensor information acquisition section 53 acquires sensor information (e.g., video data from the camera 32 in FIG. 1 or acceleration data from the acceleration sensor 33) output from the sensor section 34 of the vehicle 23 and supplies it to the scenery moving direction calculation section 54.

The scenery moving direction calculation section 54 calculates the scenery moving direction based on the sensor information supplied from the sensor information acquisition section 53. For example, in the video content distribution system 11, the scenery moving direction is calculated from the peripheral vision region outside the content area.

For example, the scenery moving direction calculation section 54 can calculate the scenery moving direction by determining the optical flow in the peripheral vision region of the video data from the camera 32. Note that the scenery moving direction calculation section 54 may also acquire video data from, for example, a drive recorder mounted on the vehicle 23, and calculate the scenery moving direction by determining the optical flow from the exterior scenery captured in the video data.

Alternatively, the scenery moving direction calculation section 54 may determine the vehicle 23's moving direction based on the acceleration data from the acceleration sensor 33 and estimate the scenery moving direction from that moving direction. Furthermore, the scenery moving direction calculation section 54 may obtain, in addition to the acceleration data from the acceleration sensor 33, information such as position information indicating the position of vehicle 23 and information indicating the steering angle of the steering wheel of vehicle 23, and calculate the moving direction of vehicle 23.

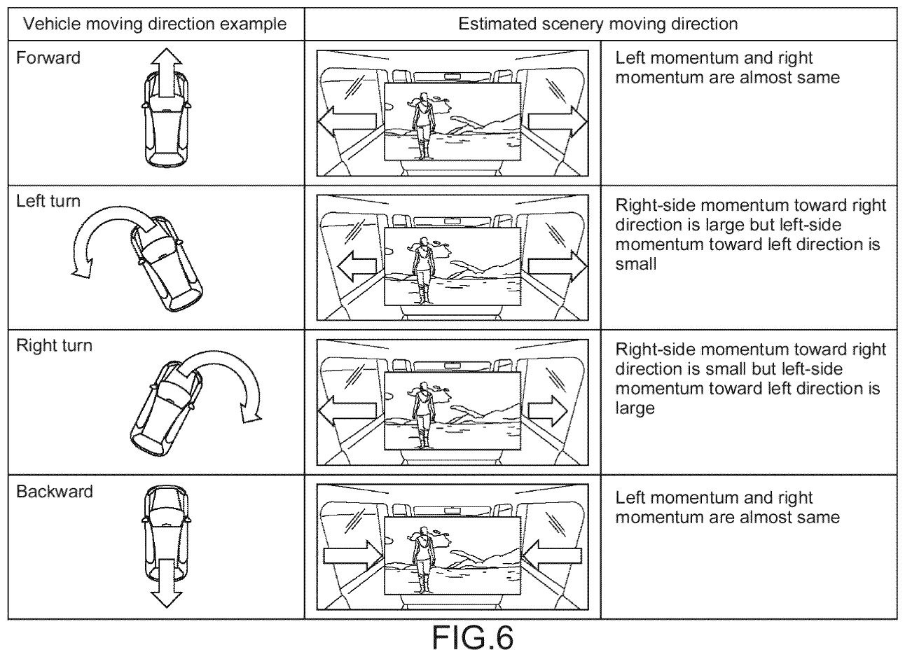

Referring to FIG. 6, an example of the estimated scenery moving direction based on the moving direction of vehicle 23 is described. For example, when the moving direction of vehicle 23 is forward, the amount of motion of the scenery moving direction toward the right in the right side of the central vision region and the amount of motion of the scenery moving direction toward the left in the left side of the central vision region are estimated to be approximately the same. When the vehicle 23 is turning left, the amount of scenery motion in the right direction in the right side of the central vision region is estimated to be large, and the amount of scenery motion in the left direction in the left side of the central vision region is estimated to be small. When the vehicle 23 is turning right, the amount of scenery motion in the right direction in the right side of the central vision region is estimated to be small, and the amount of scenery motion in the left direction in the left side of the central vision region is estimated to be large. When the moving direction of vehicle 23 is backward, the amount of scenery movement toward the left in the right side of the central vision region and the amount of scenery movement toward the right in the left side of the central vision region are estimated to be approximately the same.

The difference calculation section 55 calculates the difference D between the video moving direction calculated by the video moving direction calculation section 52 and the scenery moving direction calculated by the scenery moving direction calculation section 54, and supplies the difference information indicating the difference D to the parameter decision section 57. For example, the difference D indicated by the difference information is defined using the video moving direction V_{c} and the scenery moving direction V₁ as shown in the following equation (1).

$$\begin{matrix}[ Math . 1 ] & \\ D = \vert {V}_{c} - {V}_{1} \vert & ( 1 )\end{matrix}$$

The effect information definition section 56 stores effect information defining multiple types of effects (such as the mosaic shown in FIG. 3 and the mask shown in FIG. 4) that can be used in the effect process device 22, and parameters applicable to each type of effect. For example, the types of effects to be used may be predetermined. Additionally, although not shown, the type of effect to be used may be determined based on user instructions from the user interface.

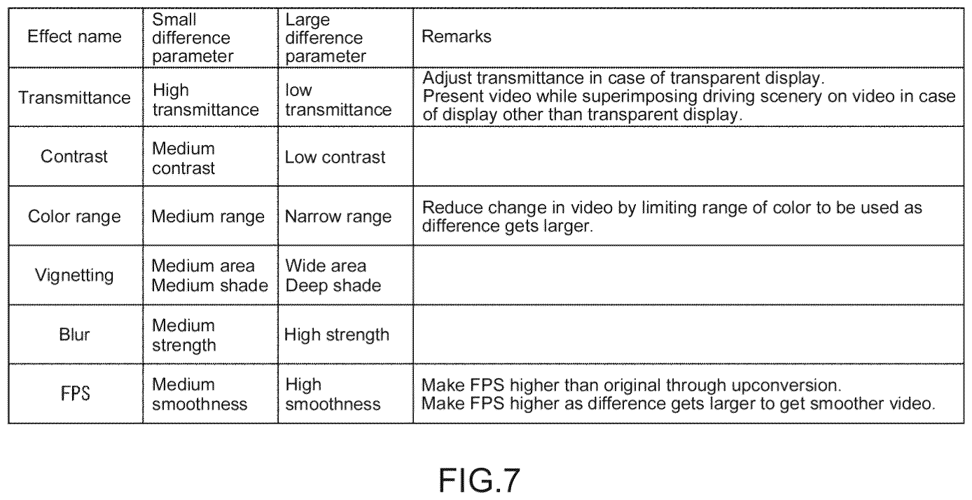

For example, as explained with reference to the above FIG. 3, when using a mosaic as an effect, if the difference between the video moving direction and the scenery moving direction is small, the small size parameter is applied as the difference small parameter that specifies the mosaic size, and if the difference between the video moving direction and the scenery moving direction is large, the large size parameter is applied as the difference large parameter that specifies the mosaic size. Additionally, as explained with reference to the above FIG. 4, when using a mask as an effect, the effect information is defined such that when the difference between the video moving direction and the scenery moving direction is small, the “narrow width” parameter is applied as the “small difference” parameter specifying the mask width, and when the difference between the video moving direction and the scenery moving direction is large, the “wide width” parameter is applied as the “large difference” parameter specifying the mask width. Note that for effects other than mosaic and mask, refer to FIG. 7 and the subsequent description.

The parameter decision section 57 determines the parameters of the effect to be applied to the video content based on the comparison result of the difference D indicated by the difference information supplied from the difference calculation section 55 with the first threshold Dₜₕ₁ and the second threshold Dₜₕ₂ shown in the following equation (2).

$$\begin{matrix}[ Math 2 ] & \\ 0 < {D}_{th 2} < {D}_{th 1} & ( 2 )\end{matrix}$$

For example, parameter decision section 57 determines to apply a large difference parameter to the effect when the difference D is larger than the first threshold Dₜₕ₁ (Dₜₕ₁<D). Furthermore, the parameter decision section 57 determines to apply a small difference parameter to the effect when the difference D is larger than the second threshold Dₜₕ₂ and less than or equal to the first threshold Dₜₕ₁ (Dₜₕ₂<D≤Dₜₕ₁). Furthermore, the parameter decision section 57 determines not to apply the effect when the difference D is less than or equal to the second threshold Dₜₕ₂ (D≤Dₜₕ₂).

The display presented video creation section 58 creates a video to be displayed on the video presentation section 31 of the vehicle 23 by applying an effect, such as an effect that directs the user's attention toward the central vision region, in accordance with the parameters determined by the parameter decision section 57 to the video content received by the content reception section 51. The display presented video creation section 58 then transmits the video content with the appropriate effects applied to reduce motion sickness to the vehicle 23. Note that if the parameter decision section 57 decides not to apply any effects, the display presented video creation section 58 transmits the video content received by the content reception section 51 to the vehicle 23 as is.

Vehicle 23 is configured with a video presentation section 31 that receives and displays video content transmitted from the effect process device 22, and a sensor section 34 that includes a camera 32 and an acceleration sensor 33 shown in FIG. 1. For example, the video presentation section 31 may use a liquid crystal display or a projector. Additionally, the sensor section 34 may be configured to include a GPS sensor for detecting the position of vehicle 23, a sensor for detecting the steering angle of the steering wheel of vehicle 23, and a camera of the drive recorder installed in vehicle 23.

As described above, the video content distribution system 11 is configured such that users can comfortably view video content while the vehicle 23 is in motion, avoiding the risk of motion sickness. In particular, the video content distribution system 11 can more effectively reduce motion sickness by applying effect processing to the video content that takes into account both the motion of the vehicle 23 and the movement of the video content. Additionally, the video content distribution system 11 can execute effect processing without using contact-type biosensors, thereby improving the user experience without increasing the user's burden. Furthermore, the video content distribution system 11 controls effect parameters based on the video moving direction and scenery moving direction, and does not apply effects when there is a low risk of motion sickness, allowing users to enjoy viewing video content without compromising the viewing experience.

FIG. 7 shows examples of effects and parameters defined in the effect information definition section 56.

When transparency is used as an effect, if a transparent display is used as the video presentation section 31, the transparency of the transparent display area corresponding to the target area to which the effect is applied is adjusted according to the transparency rate. When a display other than a transparent display is used as the video presentation section 31, the video content is displayed so that it overlaps the moving scenery, and the transparency of the video content relative to the moving scenery is adjusted according to the transparency rate. When using transparency as an effect, if the difference between the video moving direction and the scenery moving direction is small, a high transparency rate is applied as the parameter for specifying the transparency rate for small differences. On the other hand, when the difference between the video moving direction and the scenery moving direction is large, a low transparency rate is applied as the parameter for specifying the transparency rate.

When using contrast as an effect, adjust the contrast of the target area to which the effect is applied. When using contrast as an effect, when the difference between the moving direction of the video and the moving direction of the scenery is small, medium contrast is applied as the parameter for the small difference that specifies the degree of contrast. On the other hand, when the difference between the moving direction of the video and the moving direction of the scenery is large, low contrast is applied as the parameter for the large difference that specifies the degree of contrast.

When using color range as an effect, adjust the color range of the target area to which the effect is applied. When using color range as an effect, when the difference between the moving direction of the video and the moving direction of the scenery is small, the “medium range” parameter is applied as the difference small parameter that specifies the color range. On the other hand, when the difference between the video moving direction and the scenery moving direction is large, the low range is applied as the parameter for the large difference specifying the color range. In other words, the larger the difference between the video moving direction and the scenery moving direction, the narrower the color range becomes, thereby reducing video changes.

When using a vignette effect (e.g., blurring the edges of video content within a specified range), the vignette is applied to the target area where the effect is applied. When using a vignette effect, when the difference between the video moving direction and the scenery moving direction is small, the “mid” parameter for the difference small parameter that specifies the vignette range is applied, and the “mid” parameter for the difference small parameter that specifies the vignette intensity is applied. On the other hand, when the difference between the video moving direction and the scenery moving direction is large, the “large difference” parameter is applied as the parameter specifying the vignette range, and the “large difference” parameter is applied as the parameter specifying the vignette intensity.

When using blur as an effect, the blur processing is applied to the target area to which the effect is applied. When using blur as an effect, when the difference between the video moving direction and the scenery moving direction is small, the “Medium” parameter is applied as the “Small” parameter for specifying the blur intensity. On the other hand, when the difference between the video moving direction and the scenery moving direction is large, the “Large” parameter is applied as the “Large” parameter for specifying the blur intensity.

When using frame rate as an effect, adjust the effective frame rate of the target area to which the effect is applied. The effective frame rate refers to the frame rate as the ratio (or potential ratio) of image changes in the target area, rather than the frame rate dependent on the display device. For example, when displayed at 60 FPS (frames per second), if the image does not change within 60 FPS, the effective frame rate is equivalent to 1 FPS. However, if the image changes every two frames, the effective frame rate is equivalent to 30 FPS. When using frame rate as an effect, if the difference between the direction of video motion and the direction of scene motion is small, the “smoothness medium” parameter is applied as the “small difference” parameter for specifying the frame rate. On the other hand, when the difference between the video moving direction and the scene moving direction is large, the “Smoothness High” parameter is applied as the “Large Difference” parameter to specify the degree of frame rate. For example, by upconverting the frame rate, the frame rate can be increased compared to the original video content, and the higher the frame rate, the smoother the video content is displayed when the difference between the video moving direction and the scene moving direction is large.

Furthermore, the effects shown in FIGS. 3 and 4, as well as the various types of effects listed in FIG. 7, can be considered as processing that directs the user's attention toward the central vision region by applying the effects outside the central vision region. Furthermore, the effects shown in FIGS. 3 and 4, as well as the transparency, contrast, color range, vignette, and blur effects listed in FIG. 7, can also be considered as processing that reduces the amount of information (the amount of information recognized by the user) in areas outside the central vision region by applying them to areas outside the central vision region.

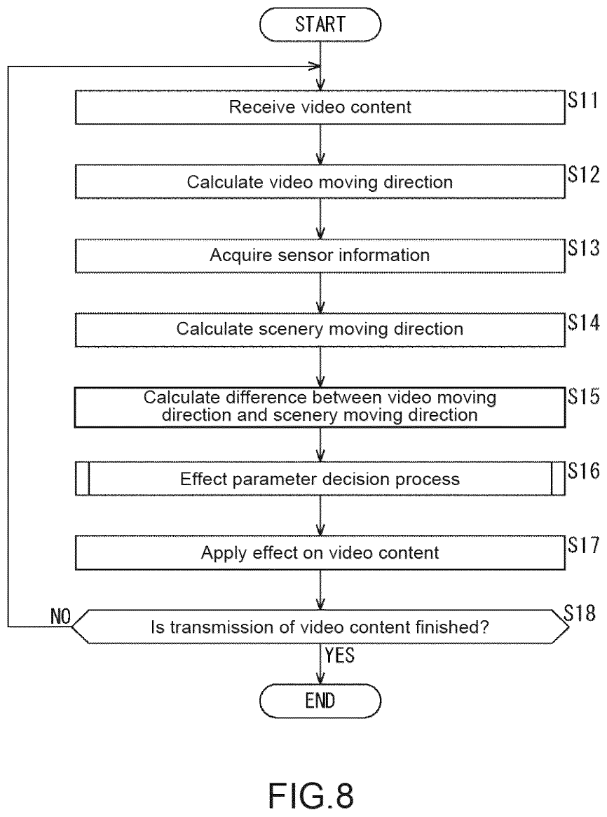

Referring to the flowchart shown in FIG. 8, the first effect processing for appropriately applying effects to video content to reduce motion sickness will be explained.

For example, when the transmission of video content from the distribution server 21 begins, the processing starts, and in Step S11, the content reception section 51 receives the video content transmitted from the distribution server 21 and supplies it to the video moving direction calculation section 52. If the user specifies the type of effect, the user specifies the type of effect when requesting the transmission of the video content.

In Step S12, the video moving direction calculation section 52 calculates the video moving direction by determining the optical flow from the video content supplied from the content receiving unit 51 in Step S11.

In Step S13, the sensor information acquisition section 53 acquires sensor information output from the sensor section 34 of the vehicle 23 and supplies it to the scenery moving direction calculation section 54.

In Step S14, the scenery moving direction calculation section 54 calculates the scenery moving direction based on the sensor information supplied from the sensor information acquisition section 53 in Step S13.

In Step S15, the difference calculation section 55 calculates the difference D between the video moving direction calculated by the video moving direction calculation section 52 in Step S12 and the scenery moving direction calculated by the scenery moving direction calculation section 54 in Step S14, and supplies the difference information indicating the difference D to the parameter decision section 57.

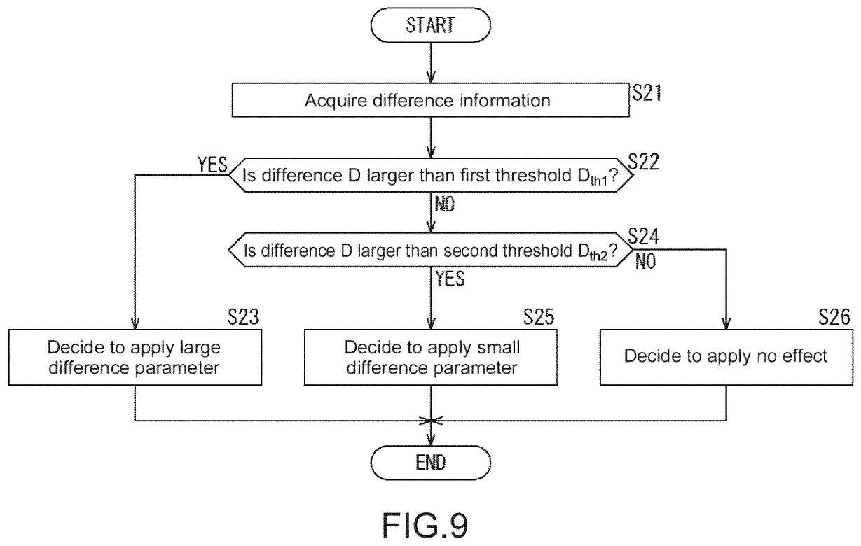

In Step S16, the parameter decision section 57 performs an effect parameter decision process (see FIG. 9) to determine the parameters of the effect to be applied to the video content based on the difference D indicated by the difference information supplied from the difference calculation section 55, the first threshold Dₜₕ₁ and the second threshold Dₜₕ₂ mentioned above, to perform an effect parameter decision process (see FIG. 9) to determine the parameters of the effect to be applied to the video content.

In Step S17, the display presented video creation section 58 applies an effect to the video content received by the content reception section 51 in Step S11 in accordance with the parameters determined by the parameter decision section 57 in Step S16. As a result, the display presented video creation section 58 obtains the video content with effects applied to reduce motion sickness and transmits it to the vehicle 23, where the video content is displayed on the video presentation section 31.

In Step S18, the effect process device 22 determines whether the transmission of video content from the distribution server 21 is finished.

In Step S18, if it is determined that the transmission of video content from the distribution server 21 is not finished, the processing returns to Step S11, and the same processing is repeated. On the other hand, if it is determined in Step S18 that the transmission of video content from the distribution server 21 is finished, the processing is terminated.

FIG. 9 is a flowchart illustrating the effect parameter decision process performed in Step S16 of FIG. 8.

In Step S21, the parameter decision section 57 acquires the difference information indicating the difference D calculated by the difference calculation section 55 in Step S15 of FIG. 8.

In Step S22, the parameter decision section 57 determines whether the difference D is larger than or equal to the first threshold Dₜₕ₁.

In Step S22, if the parameter decision section 57 determines that the difference D is larger than the first threshold Dₜₕ₁, the processing proceeds to Step S23. In Step S23, the parameter decision section 57 decides to apply the parameter corresponding to the large difference to the effect, and the processing is terminated.

On the other hand, in Step S22, if the parameter decision section 57 determines that the difference D is not larger than the first threshold Dₜₕ₁ (i.e., the difference D is less than or equal to the first threshold Dₜₕ₁), the processing proceeds to Step S24.

In Step S24, the parameter decision section 57 determines whether the difference D is larger than the second threshold Dₜₕ₂.

In Step S24, if the parameter decision section 57 determines that the difference D is larger than the second threshold Dₜₕ₂, the processing proceeds to Step S25. In Step S25, the parameter decision section 57 decides to apply a small difference parameter to the effect, and the processing is terminated.

On the other hand, in Step S24, if the parameter decision section 57 determines that the difference D is not larger than the second threshold Dₜₕ₂ (i.e., the difference D is less than or equal to the second threshold Dₜₕ₂), the processing proceeds to Step S26.

In Step S26, the parameter decision section 57 determines not to apply the effect, and the processing is terminated.

Through the first effect processing described above, an effect to reduce motion sickness can be appropriately applied to the video content, enabling the video content distribution system 11 to provide a more comfortable viewing experience. Note that the processing described in FIGS. 8 and 9 may be performed in a different order or asynchronously.

### <Second Configuration Example of the Video Content Distribution System>

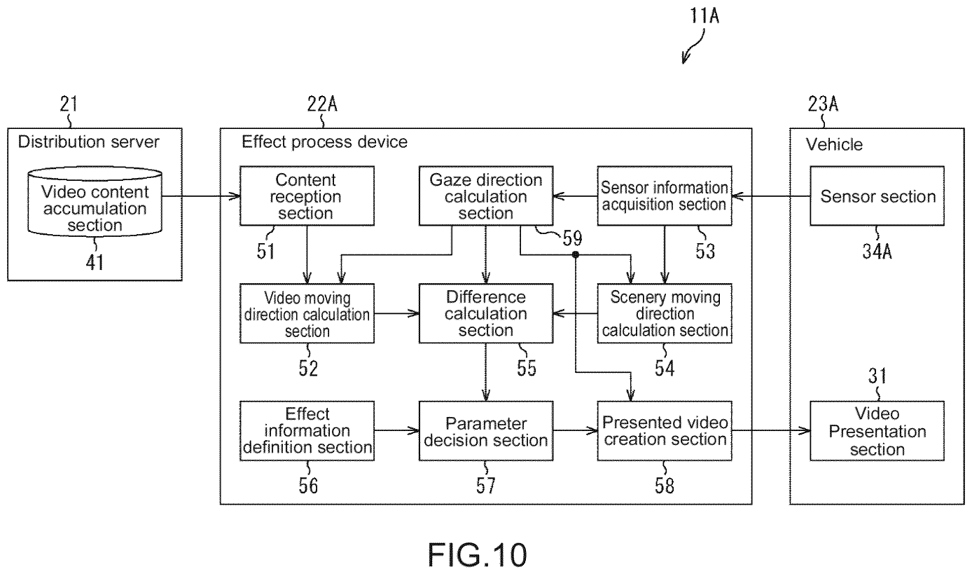

Referring to FIGS. 10 to 15, the second configuration example of the video content distribution system 11 is described.

FIG. 10 shows a block diagram of the video content distribution system 11A. Note that in the video content distribution system 11A shown in FIG. 10, blocks common to the video content distribution system 11 shown in FIG. 5 are labeled with the same symbols, and their detailed descriptions are omitted. Additionally, in the video content distribution system 11A, the effects shown in FIGS. 3 and 4, as well as the various types of effects listed in FIG. 7, are used in the same manner as in the video content distribution system 11 shown in FIG. 5.

In the video content distribution system 11A, the sensor section 34A of the vehicle 23A includes, in addition to the various sensors included in the sensor section 34 of the video content distribution system 11 in FIG. 5, non-contact sensors such as an eye-tracking sensor for detecting eye movements and a face recognition camera for acquiring images for face recognition, which are used to determine the central vision region corresponding to the center of the user's vision region who is viewing the video content.

Furthermore, in the video content distribution system 11A, the effect process device 22A is configured to include, in addition to the content reception section 51, the video moving direction calculation section 52, the sensor information acquisition section 53, the scenery moving direction calculation section 54, the difference calculation section 55, the effect information definition section 56, the parameter decision section 57, and the presented video creation section 58, a gaze direction calculation section 59.

The gaze direction calculation section 59 receives data output from the gaze sensor or face recognition camera among the sensor information acquired by the sensor information acquisition section 53 from the sensor section 34A. The gaze direction calculation section 59 calculates the user's gaze direction based on the data output from the gaze sensor or face recognition camera, and identifies the central vision region from that gaze direction. Then, the gaze direction calculation section 59 supplies information indicating the central vision region to the video moving direction calculation section 52, the scenery moving direction calculation section 54, and the display presented video creation section 58.

As a result, the effect process device 22A can perform effect processing to appropriately apply effects to the video content to reduce motion sickness by referring to the central vision region identified by the gaze direction calculation section 59.

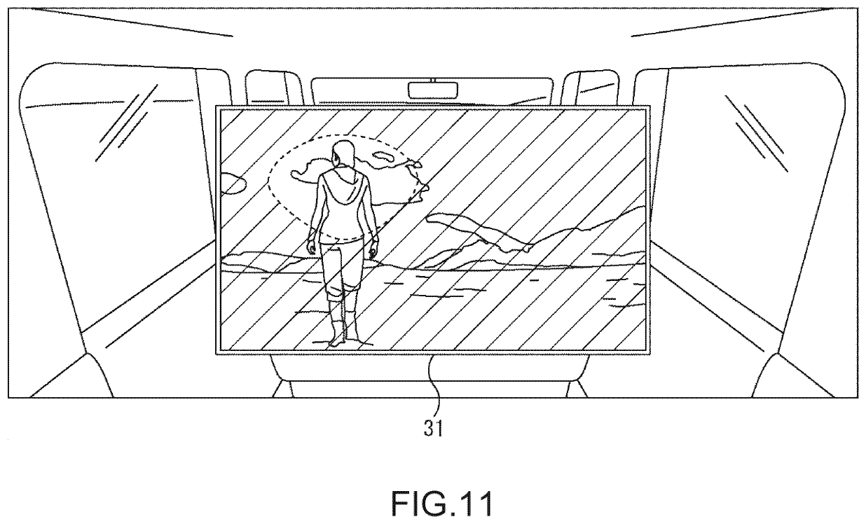

The display presented video creation section 58 applies effects to the areas of the video content outside the central vision region, i.e., the areas where diagonal hatching is applied in the video content displayed on the video presentation section 31, when the area enclosed by the dashed frame shown in FIG. 11 is the central vision region.

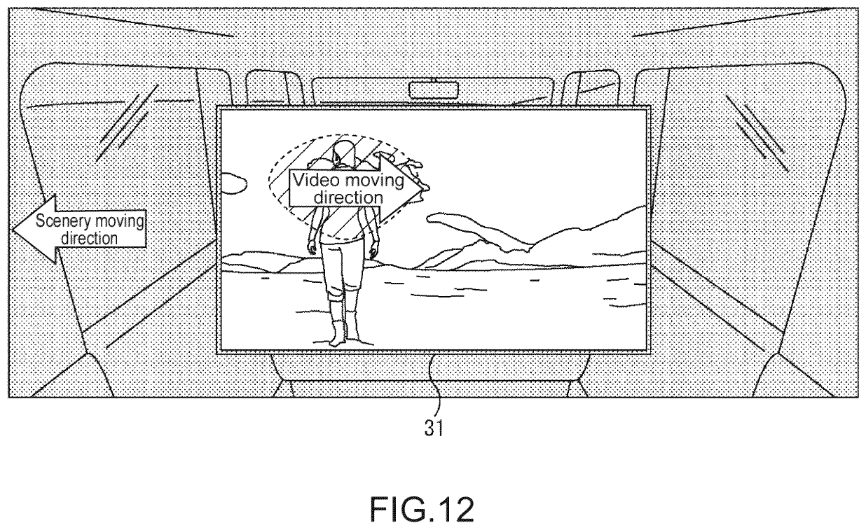

The video moving direction calculation section 52 calculates the video moving direction using the optical flow obtained from the central vision region, rather than the optical flow obtained from the entire video content, when the area enclosed by the dashed frame shown in FIG. 12 is the central vision region.

The scenery moving direction calculation section 54 can define the area with dotted hatching in FIG. 12 as the peripheral vision region for calculating the scenery moving direction. For example, the scenery moving direction calculation section 54 can calculate the scenery moving direction by defining the area outside the content area, which is the area where the video content is displayed, as the peripheral vision region in the video captured by the camera 32.

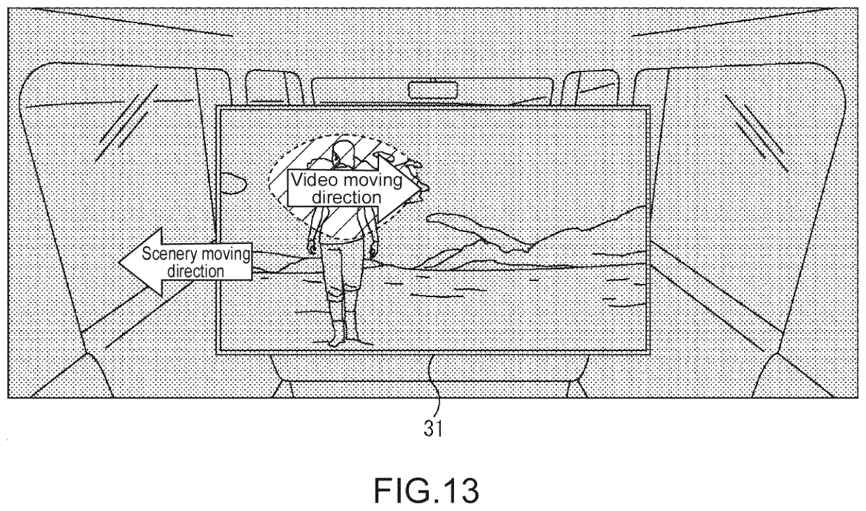

Alternatively, the scenery moving direction calculation section 54 can set the area with dotted hatching in FIG. 13 as the peripheral vision region for calculating the scenery moving direction. For example, the scenery moving direction calculation section 54 can calculate the scenery moving direction by setting the area outside the content area, which is the area where the video content is displayed, and the area other than the central vision region in the video captured by the camera 32 as the peripheral vision region.

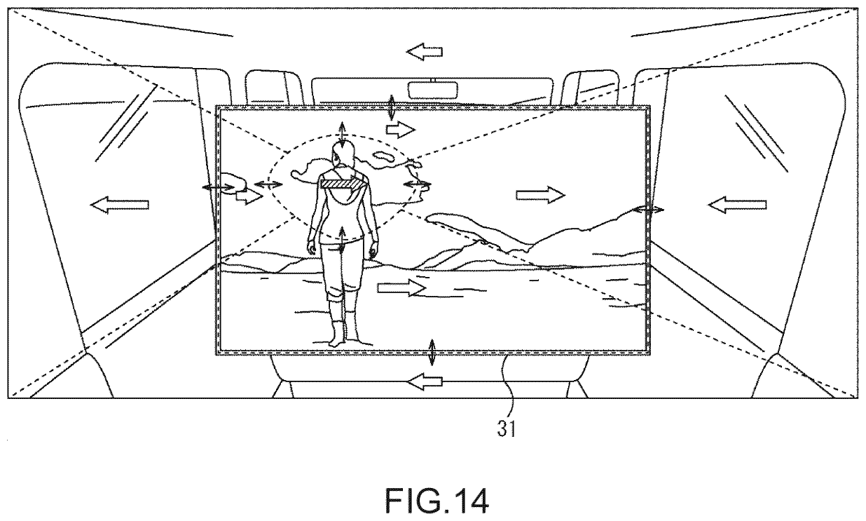

Furthermore, the scenery moving direction calculation section 54 can divide the peripheral vision region into multiple areas, as shown by the broken lines in FIG. 14, and calculate the scenery moving direction for each area in the video captured by the camera 32. In the example shown in FIG. 14, the content area outside the peripheral vision region is subdivided radially toward the four corners of the video captured by camera 32, centered on the central vision region. The scenery moving direction calculation section 54 calculates the optical flow for each area to determine the scenery moving direction for each area, and then calculates the sum of the differences between the scenery moving directions of adjacent areas as the scenery moving direction for the peripheral vision region.

The difference calculation section 55 calculates the difference D between the video moving direction of the central vision region calculated by the video moving direction calculation section 52 (the hatched arrows in FIG. 14) and the scenery moving direction in the peripheral vision region calculated from the scenery moving directions of the multiple areas calculated by the scenery moving direction calculation section 54 (the white arrows in FIG. 14).

As described above, the video content distribution system 11A is configured such that, similar to the video content distribution system 11 shown in FIG. 1, users can comfortably view video content while avoiding the risk of motion sickness even in a moving vehicle 23. In particular, the video content distribution system 11A achieves the effect of directing the user's attention toward the central visual field area by applying effects to content areas other than the central visual field area identified from the user's gaze, thereby enhancing the effect of reducing motion sickness.

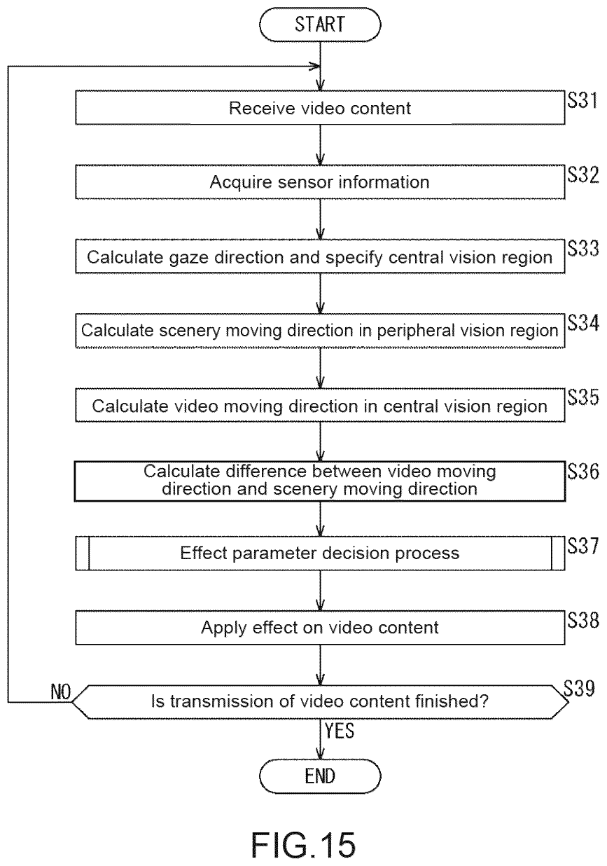

Referring to the flowchart shown in FIG. 15, we will explain the second effect processing that appropriately applies effects to video content to reduce motion sickness.

For example, when the transmission of video content from the distribution server 21 begins, the processing starts, and in Step S31, the content reception section 51 receives the video content transmitted from the distribution server 21 and supplies it to the video moving direction calculation section 52. If the user specifies the type of effect, the user specifies the type of effect when requesting the transmission of video content.

In Step S32, the sensor information acquisition section 53 acquires sensor information output from the sensor section 34 of the vehicle 23 and supplies it to the scenery moving direction calculation section 54 and the gaze direction calculation section 59.

In Step S33, the gaze direction calculation section 59 calculates the user's gaze direction based on the sensor information (e.g., data output from an unillustrated gaze sensor or face recognition camera) supplied from the sensor information acquisition section 53 in Step S32, and identifies the central vision region from the gaze direction.

In Step S34, the scenery moving direction calculation section 54 calculates the scenery moving direction in the peripheral vision region by determining the optical flow of the peripheral vision region outside the central vision region identified in Step S33 based on the sensor information (e.g., video data from camera 32 in FIG. 1) supplied from the sensor information acquisition section 53 in Step S32.

In Step S35, the video moving direction calculation section 52 calculates the video moving direction in the central vision region by obtaining the optical flow of the central vision region specified in Step S33 from the video content supplied from the content reception section 51 in Step S31.

Thereafter, in Steps S36 to S39, the same processing as in Steps S15 to S18 of FIG. 8 is performed, and in Step S39, if it is determined that the transmission of the video content from the distribution server 21 is finished, the processing is terminated.

Through the above-described second effect processing, effects to reduce motion sickness can be appropriately applied to the video content in accordance with the central visual field area determined based on the user's gaze direction, enabling the video content distribution system 11 to provide a more comfortable viewing experience.

### <Correction of the Vertical Direction of Scenery Motion>

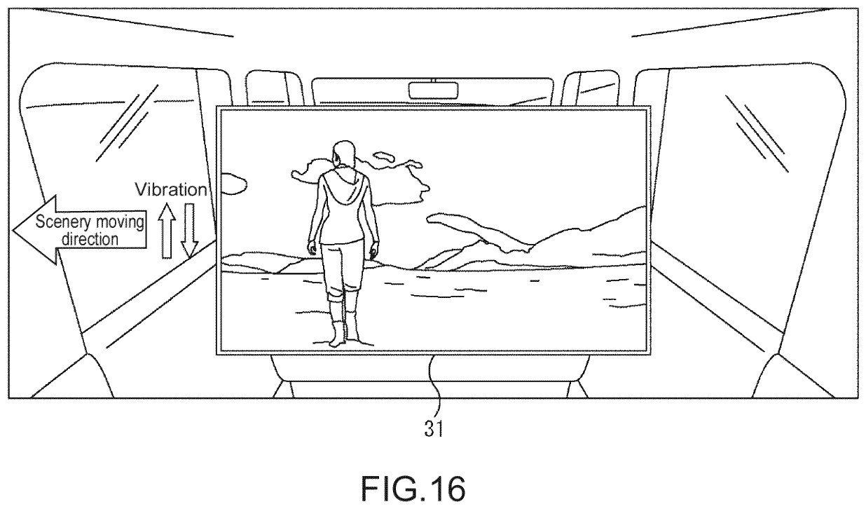

Referring to FIG. 16, we will explain the correction of the vertical direction of the scenery moving direction accompanying the vibration of the vehicle 23.

For example, when vehicle 23 is traveling and vibrates due to road surface irregularities, the vision region of passengers in vehicle 23 vibrates vertically. Therefore, the sensor section 34 of vehicle 23 is configured to include a vibration sensor, and the scenery moving direction calculation section 54 is configured to acquire data output from the vibration sensor via the sensor information acquisition section 53. As a result, the scenery moving direction calculation section 54 can more accurately determine the scenery moving direction by correcting the scenery moving direction estimated from, for example, position information indicating the position of vehicle 23 and information indicating the steering angle of the vehicle 23's steering wheel, based on the data output from the vibration sensor in the vertical direction.

Therefore, the video content distribution system 11 can enhance the effectiveness of motion sickness reduction effects by determining the scenery moving direction in response to the overall blur of the user's vision region caused by vehicle vibrations, thereby providing a more comfortable viewing experience.

### <Modified Example of the Video Content Distribution System>

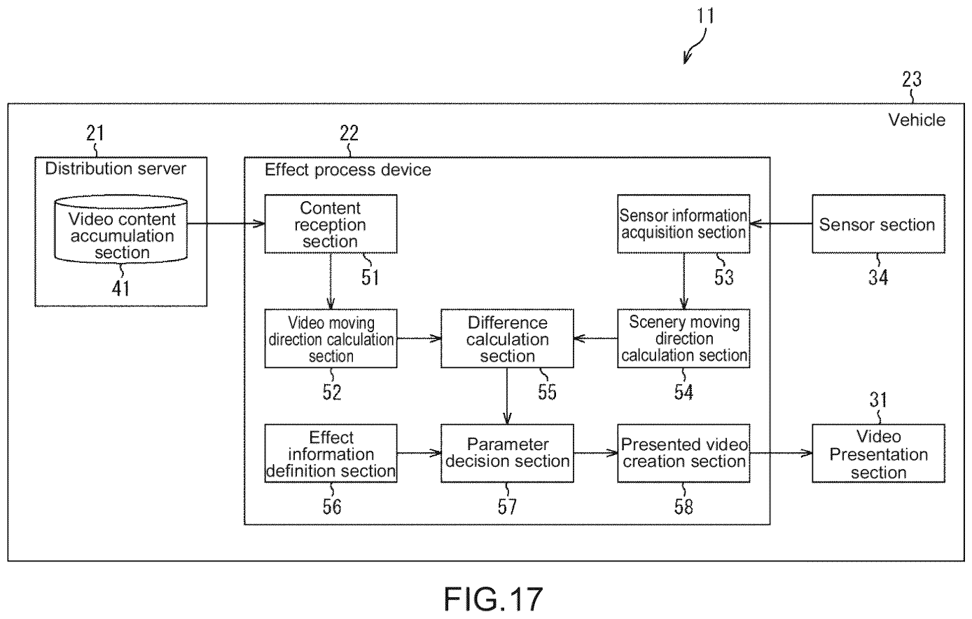

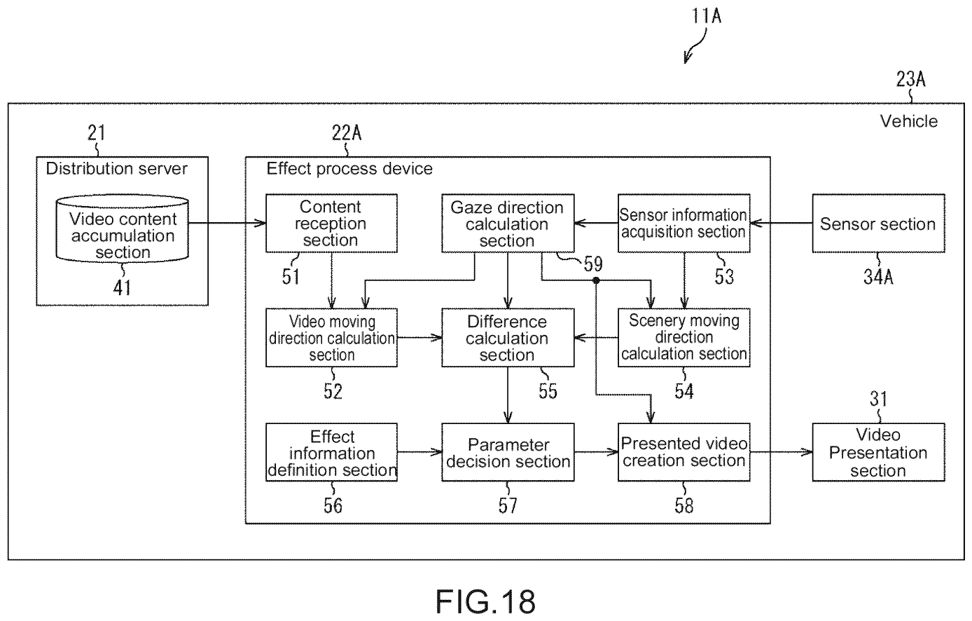

Referring to FIGS. 17 and 18, an example of a modified video content distribution system 11 is described.

FIG. 17 is a diagram showing a modified example of the video content distribution system 11 shown in FIG. 5. In FIG. 17, blocks with the same numbers as the blocks in FIG. 5 provide the same functions as the blocks in FIG. 5.

The video content distribution system 11 shown in FIG. 17 is configured with a distribution server 21 and an effect process device 22 mounted on a vehicle 23. In other words, in the video content distribution system 11 shown in FIG. 5, video content distributed from the distribution server 21 and effect-processed by the effect process device 22 was received by the vehicle 23 via a communication network and then displayed on the video presentation section 31. In contrast, in the video content distribution system 11 shown in FIG. 17, video content that is played back by the distribution server 21 and undergoes effect processing by the effect process device 22 is displayed on the video presentation section 31 within the vehicle 23.

FIG. 18 is a diagram showing a modified example of the video content distribution system 11A shown in FIG. 10. In FIG. 18, blocks with the same numbers as the blocks in FIG. 10 provide the same functions as the blocks in FIG. 10.

The video content distribution system 11A shown in FIG. 18 is configured similarly to the video content distribution system 11 shown in FIG. 17, with the distribution server 21 and effect process device 22A mounted on the vehicle 23A.

In this way, the video content distribution system 11 (11A) can perform effect processing to appropriately apply effects to video content for the purpose of reducing motion sickness while reproducing video content in the vehicle 23 (23A).

### <Example of Computer Configuration>

The aforementioned series of processes (video processing method) can be performed using hardware or software. When the series of processes is performed using software, the program constituting the software is installed on a general-purpose computer or the like.

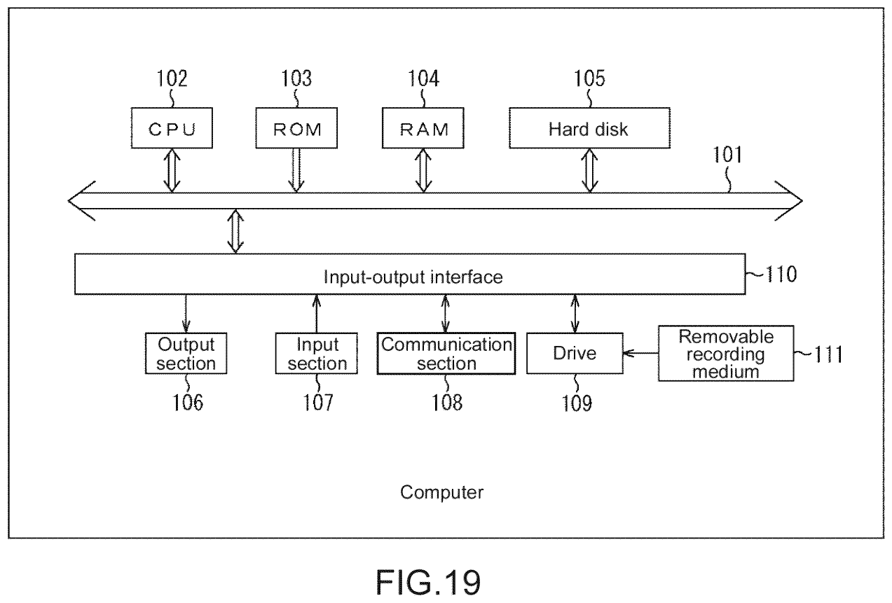

FIG. 19 is a block diagram showing an example of the configuration of a computer in which the program that executes the above-mentioned series of processes is installed.

The program can be pre-recorded on a hard disk 105 or ROM 103, which serve as recording medium built into the computer.

Alternatively, the program may be stored (recorded) on a removable recording medium 111 driven by a drive 109. Such a removable recording medium 111 may be provided as so-called packaged software. Here, examples of removable recording medium 111 include flexible disks, CD-ROM (Compact Disc Read Only Memory), MO (Magneto Optical) disks, DVD (Digital Versatile Disc), magnetic disks, semiconductor memory, etc.

Additionally, the program can be installed on a computer not only by installing it from the aforementioned removable recording medium 111 but also by downloading it via a communication network or broadcast network and installing it on the internal hard disk 105. That is, programs can be wirelessly transferred to a computer via a digital satellite broadcast satellite from a download site, or transferred to a computer via a network such as a LAN (Local Area Network) or the Internet using a wired connection.

The computer includes a CPU (Central Processing Unit) 102, and the CPU 102 is connected to an input-output interface 110 via a bus 101.

When instructions are input via the input section 107 operated by the user through the input-output interface 110, the CPU 102 executes the program stored in the ROM (Read Only Memory) 103 in accordance with the instructions. Alternatively, the CPU 102 loads the program stored in the hard disk 105 into the RAM (Random Access Memory) 104 and executes it.

As a result, CPU 102 performs the processing described in the above flowchart or the processing performed according to the configuration of the above block diagram. Then, CPU 102 outputs the processing results, as necessary, for example, through input-output interface 110 from output section 106, transmits them through communication section 108, or records them in hard disk 105.

Note that the input section 107 is composed of a keyboard, mouse, microphone, etc. The output section 106 is composed of an LCD (Liquid Crystal Display), speaker, etc.

Here, the processing performed by the computer in accordance with the program in this specification does not necessarily need to be performed in the order shown in the flowchart in a time-series manner. That is, the processing performed by the computer in accordance with the program includes parallel or individual processing (e.g., parallel processing or object-oriented processing).

Furthermore, the program may be processed by a single computer (processor) or distributed among multiple computers. Additionally, the program may be transferred to a remote computer for execution.

Furthermore, in this specification, a system refers to a collection of multiple components (devices, modules (parts), etc.), regardless of whether all components are housed in the same enclosure. Therefore, multiple devices housed in separate enclosures and connected via a network, as well as a single device containing multiple modules housed in a single enclosure, are both considered systems.

Furthermore, the configuration described as a single device (or processing unit) may be divided into multiple devices (or processing units). Conversely, the configuration described as multiple devices (or processing units) may be combined into a single device (or processing unit). Additionally, other configurations not mentioned above may be added to the configuration of each device (or processing unit). Furthermore, if the overall configuration or operation of the system remains substantially the same, it is permissible to include part of the configuration of one device (or processing unit) in the configuration of another device (or processing unit).

Additionally, for example, the present technology may adopt a cloud computing configuration where a single function is distributed and processed collaboratively across multiple devices via a network.

Furthermore, for example, the program described above can be executed on any device. In such a case, the device should be configured to have the necessary functions (such as function blocks) and to be able to obtain the necessary information.

Furthermore, each step described in the flowchart above can be executed on a single device or distributed across multiple devices. Furthermore, if a single step includes multiple processes, the multiple processes contained in that single step can be executed on a single device or distributed across multiple devices. In other words, the multiple processes contained in a single step can be executed as multiple steps. Conversely, the processes described as multiple steps can be executed as a single step.

Furthermore, the program executed by the computer may be executed in the order described in this specification, or may be executed in parallel or individually at the necessary timing, such as when a call is made. In other words, as long as there is no contradiction, the processing of each step may be executed in an order different from the order described above. Furthermore, the processing of the steps describing this program may be executed in parallel with the processing of other programs or combined with the processing of other programs.

Note that the technologies described multiple times in this specification may be implemented independently as long as no conflicts arise. Of course, any combination of multiple technologies may also be implemented. For example, some or all of the technologies described in one implementation may be combined with some or all of the technologies described in another implementation. In addition, some or all of the technologies described above may be implemented in combination with other technologies not described above.

### <Example of Combination of Configurations>

Furthermore, the present technology may also have the following configurations.

(1) A video processing apparatus, comprising:
a video moving direction calculation section that calculates a direction in which a video moves based on a content of a video content displayed by a video presentation section in a vehicle;
a scenery moving direction calculation section that calculates a direction in which a scenery outside the vehicle moves based on the vehicle's motion; and
a presented video creation section that creates a video displayed by the video presentation section by applying an effect to the video content based on both the video moving direction and the scenery moving direction.

(2) The video processing apparatus according to the aforementioned (1), wherein
the video moving direction is determined based on a central vision region, that is estimated as a center of a vision region of a user viewing the video content in the vehicle, and
the scenery moving direction is determined from a peripheral vision region located outside the central vision region.

(3) The video processing apparatus according to the aforementioned (2), wherein
the central vision region is a content area where the video content is displayed by the video presentation section.

(4) The video processing apparatus according to the aforementioned (3), wherein
the presented video creation section applies the effect to the entire video content.

(5) The video processing apparatus according to the aforementioned (2), wherein
the central vision region is a part of a content area specified based on the user's gaze.

(6) The video processing apparatus according to the aforementioned (5), wherein
the presented video creation section applies the effect to the peripheral vision region outside the central vision region of the video content.

(7) The video processing apparatus according to the aforementioned (5) or (6), wherein
the user's gaze is detected by a non-contact sensor.

(8) The video processing apparatus according to any one of the aforementioned (2) to (7), wherein
the presented video creation section applies the effect that directs the user's attention to the central vision region to the video content.

(9) The video processing apparatus according to any one of the aforementioned (1) to (8), wherein
the presented video creation section applies an effect that reduces an amount of information in the image area where the effect is applied to the video content.

(10) The video processing apparatus according to any one of the aforementioned (1) to (9), further comprising:
a difference calculation section that calculates a difference between the video moving direction and the scenery moving direction; and
a parameter decision section that determines parameters to be applied to the effect based on the magnitude of the difference), wherein
the presented video creation section applies the effect corresponding to the difference to the video content.

(11) The video processing device according to the aforementioned (10), wherein
the parameter decision section, when using mosaic as the effect, determines a parameter that specifies a small size for the mosaic when the difference is small, and determines a parameter that specifies a large size for the mosaic when the difference is large.

(12) The video processing apparatus according to the aforementioned (10), wherein
the parameter decision section, when using a mask as the effect, determines a parameter that specifies a width of the mask as narrow when the difference is small, and determines a parameter that specifies a width of the mask as wide when the difference is large.

(13) The video processing apparatus according to any one of the aforementioned (10) to (12), wherein
the parameter decision section determines not to apply the effect when the difference is less than or equal to a predetermined threshold.

(14) The video processing apparatus according to any one of the aforementioned (1) to (13), wherein
the video moving direction calculation section calculates the video moving direction based on an optical flow obtained from the content of the video content.

(15) The video processing apparatus according to any one of the aforementioned (1) to (14), wherein
the scenery moving direction calculation section calculates the moving direction of the vehicle based on acceleration data from an acceleration sensor installed on the vehicle, and estimates the scenery moving direction from the moving direction.

(16) The video processing apparatus according to any one of the aforementioned (1) to (14), wherein
the scenery moving direction calculation section calculates the scenery moving direction by determining an optical flow from video data obtained from a camera installed on the vehicle.

(17) The video processing apparatus according to the aforementioned (16), wherein
the video moving direction calculation section calculates the video moving direction based on the optical flow obtained from the content of the video content in the central vision region, which is the center of the user's vision region while viewing the video content in the vehicle, and
the scenery moving direction calculation section calculates the scenery moving direction based on the optical flow obtained from the peripheral vision region, which is the area outside the central vision region, in the video data from the camera.

(18) The video processing apparatus according to the aforementioned (17), wherein
the scenery moving direction calculation section divides the peripheral vision region into multiple regions centered on the central vision region and calculates the scenery moving direction for each region.

(19) The video processing apparatus according to any one of the aforementioned (1) to (18), wherein
the scenery moving direction calculation section corrects the scenery moving direction based on vibration of the vehicle.

(20) A video processing method by a video processing apparatus, comprising:
calculating a direction in which a video moves based on a content of a video content displayed by a video presentation section in a vehicle;
calculating a direction in which a scenery outside the vehicle moves based on the vehicle's motion; and
creating a video displayed by the video presentation section by applying an effect to the video content based on both the video moving direction and the scenery moving direction.

(21) A program for causing a computer of a video processing apparatus to execute the steps of:
calculating a direction in which a video moves based on a content of a video content displayed by a video presentation section in a vehicle;
calculating a direction in which a scenery outside the vehicle moves based on the vehicle's motion; and
creating a video displayed by the video presentation section by applying an effect to the video content based on both the video moving direction and the scenery moving direction.

(22) A video processing system, comprising:
a video moving direction calculation section that calculates a direction in which a video moves based on a content of a video content displayed by a video presentation section in a vehicle;
a scenery moving direction calculation section that calculates a direction in which a scenery outside the vehicle moves based on the vehicle's motion;
a presented video creation section that creates a video displayed by the video presentation section by applying an effect to the video content based on both the video moving direction and the scenery moving direction; and
the video presentation section that displays the video.

Note that the present embodiment is not limited to the above-described embodiment, and various modifications may be made within the scope of the disclosure. Furthermore, the effects described in this specification are merely examples and are not limited thereto, and other effects may also be obtained.

### REFERENCE SIGNS LIST

11 video content distribution system
21 distribution server
22 effect process device
23 vehicle
31 video presentation section
32 camera
33 acceleration sensor
34 sensor section
41 video content accumulation section
51 content reception section
52 video moving direction calculation section
53 sensor information acquisition section
54 scenery moving direction calculation section
55 difference calculation section
56 effect information definition section
57 parameter decision section
58 presented video creation section
59 gaze direction calculation section

1. A video processing apparatus, comprising:
a video moving direction calculation section that calculates a direction in which a video moves based on a content of a video content displayed by a video presentation section in a vehicle;
a scenery moving direction calculation section that calculates a direction in which a scenery outside the vehicle moves based on the vehicle's motion; and
a presented video creation section that creates a video displayed by the video presentation section by applying an effect to the video content based on both the video moving direction and the scenery moving direction.

2. The video processing apparatus according to claim 1, wherein
the video moving direction is determined based on a central vision region, that is estimated as a center of a vision region of a user viewing the video content in the vehicle, and
the scenery moving direction is determined from a peripheral vision region located outside the central vision region.

3. The video processing apparatus according to claim 2, wherein
the central vision region is a content area where the video content is displayed by the video presentation section.

4. The video processing apparatus according to claim 3, wherein
the presented video creation section applies the effect to the entire video content.

5. The video processing apparatus according to claim 2, wherein
the central vision region is a part of a content area specified based on the user's gaze.

6. The video processing apparatus according to claim 5, wherein
the presented video creation section applies the effect to the peripheral vision region outside the central vision region of the video content.

7. The video processing apparatus according to claim 5, wherein
the user's gaze is detected by a non-contact sensor.

8. The video processing apparatus according to claim 2, wherein
the presented video creation section applies the effect that directs the user's attention to the central vision region to the video content.

9. The video processing apparatus according to claim 1, wherein
the presented video creation section applies an effect that reduces an amount of information in the image area where the effect is applied to the video content.

10. The video processing apparatus according to claim 1, further comprising:
a difference calculation section that calculates a difference between the video moving direction and the scenery moving direction; and
a parameter decision section that determines parameters to be applied to the effect based on the magnitude of the difference, wherein
the presented video creation section applies the effect corresponding to the difference to the video content.

11. The video processing device according to claim 10, wherein
the parameter decision section, when using mosaic as the effect, determines a parameter that specifies a small size for the mosaic when the difference is small, and determines a parameter that specifies a large size for the mosaic when the difference is large.

12. The video processing apparatus according to claim 10, wherein
the parameter decision section, when using a mask as the effect, determines a parameter that specifies a width of the mask as narrow when the difference is small, and determines a parameter that specifies a width of the mask as wide when the difference is large.

13. The video processing apparatus according to claim 10, wherein
the parameter decision section determines not to apply the effect when the difference is less than or equal to a predetermined threshold.

14. The video processing apparatus according to claim 1, wherein
the video moving direction calculation section calculates the video moving direction based on an optical flow obtained from the content of the video content.

15. The video processing apparatus according to claim 1, wherein
the scenery moving direction calculation section calculates the moving direction of the vehicle based on acceleration data from an acceleration sensor installed on the vehicle, and estimates the scenery moving direction from the moving direction.

16. The video processing apparatus according to claim 1, wherein
the scenery moving direction calculation section calculates the scenery moving direction by determining an optical flow from video data obtained from a camera installed on the vehicle.

17. The video processing apparatus according to claim 16, wherein
the video moving direction calculation section calculates the video moving direction based on the optical flow obtained from the content of the video content in the central vision region, which is the center of the user's vision region while viewing the video content in the vehicle, and
the scenery moving direction calculation section calculates the scenery moving direction based on the optical flow obtained from the peripheral vision region, which is the area outside the central vision region, in the video data from the camera.

18. The video processing apparatus according to claim 17, wherein
the scenery moving direction calculation section divides the peripheral vision region into multiple regions centered on the central vision region and calculates the scenery moving direction for each region.

19. The video processing apparatus according to claim 1, wherein
the scenery moving direction calculation section corrects the scenery moving direction based on vibration of the vehicle.

20. A video processing method by a video processing apparatus, comprising:
calculating a direction in which a video moves based on a content of a video content displayed by a video presentation section in a vehicle;
calculating a direction in which a scenery outside the vehicle moves based on the vehicle's motion; and
creating a video displayed by the video presentation section by applying an effect to the video content based on both the video moving direction and the scenery moving direction.

21. A program for causing a computer of a video processing apparatus to execute the steps of:
calculating a direction in which a video moves based on a content of a video content displayed by a video presentation section in a vehicle;
calculating a direction in which a scenery outside the vehicle moves based on the vehicle's motion; and
creating a video displayed by the video presentation section by applying an effect to the video content based on both the video moving direction and the scenery moving direction.

22. A video processing system, comprising:
a video moving direction calculation section that calculates a direction in which a video moves based on a content of a video content displayed by a video presentation section in a vehicle;
a scenery moving direction calculation section that calculates a direction in which a scenery outside the vehicle moves based on the vehicle's motion;
a presented video creation section that creates a video displayed by the video presentation section by applying an effect to the video content based on both the video moving direction and the scenery moving direction; and
the video presentation section that displays the video.
